(19) United States
(12) Patent Application Publication
(10) Pub. No.: US 2003/0117906 A1
(43) Pub. Date: Jun. 26, 2003

(54) Apparatus and method for optimizing hydrodynamic groove shape

(76) Inventor: Mohamed Mizanur Rahman, San Jose, CA (US)

Correspondence Address: MOSER, PATTERSON & SHERIDAN, LLP, Suite 250, 350 Cambridge Avenue, Palo Alto, CA, 94306-4036, US

(21) Appl. No.: 10/113,735

(22) Filed: Mar. 27, 2002

Related U.S. Application Data
(60) Provisional application No. 60/342,899, filed on Dec. 20, 2001.

(51) Int. Cl. G11B 11/00

(52) U.S. Cl. 369/13.35

(57) ABSTRACT

Embodiments of the invention generally provide a method for optimizing the performance of a hydrodynamic bearing used with a disc drive. In one embodiment, the invention provides a method to determine a range of dimension values associated with at least one hydrodynamic groove disposed on the hydrodynamic bearing to improve at least one or more hydrodynamic bearing performance factors. In another embodiment, the invention provides a hydrodynamic bearing having at least one cross-section dimension associated with an optimum radial stiffness for at least one hydrodynamic groove shape. In another embodiment, the invention provides a hydrodynamic bearing having at least one groove pitch ratio associated with an optimum radial stiffness for at least one hydrodynamic groove shape.

### CROSS-REFERENCE TO A RELATED APPLICATION

This invention is based on U.S. Provisional Patent Application Serial No. 60/342,899 filed Dec. 20, 2001, entitled “Optimum Groove Depth And Groove Pitch Ratio For Different types of Groove Shape For Hydrobearing” filed in the name of Mohamed Mizanur Rahman. The priority of this provisional application is hereby claimed.

### BACKGROUND OF THE INVENTION

1. Field of the Invention

The invention relates generally to the field of disc drives, and more particularly to an apparatus and method for providing a reliable characterization of hydrodynamic grooves in a disc drive.

2. Description of the Related Art

Disc drives are capable of storing large amounts of digital data in a relatively small area. Disc drives store information on one or more recording media. The recording media conventionally takes the form of a circular storage disc, e.g., media, having a plurality of concentric circular recording tracks. A typical disc drive has one or more discs for storing information. This information is written to and read from the discs using read/write heads mounted on actuator arms that are moved from track to track across surfaces of the discs by an actuator mechanism.

Generally, the discs are mounted on a spindle that is turned by a spindle motor to pass the surfaces of the discs under the read/write heads. The spindle motor generally includes a shaft fixed to a base plate and a hub, to which the spindle is attached, having a sleeve into which the shaft is inserted. Permanent magnets attached to the hub interact with a stator winding on the base plate to rotate the hub relative to the shaft. In order to facilitate rotation, one or more bearings are usually disposed between the hub and the shaft.

Over the years, storage density has tended to increase and the size of the storage system has tended to decrease. This trend has lead to greater precision and lower tolerance in the manufacturing and operating of magnetic storage discs. For example, to achieve increased storage densities the read/write heads must be placed increasingly close to the surface of the storage disc. This proximity requires that the disc rotate substantially in a single plane. A slight wobble or run-out in disc rotation can cause the surface of the disc to contact the read/write heads. This is known as a “crash” and can damage the read/write heads and surface of the storage disc resulting in loss of data.

From the foregoing discussion, it can be seen that the bearing assembly which supports the storage disc is of critical importance. One typical bearing assembly comprises ball bearings supported between a pair of races which allow a hub of a storage disc to rotate relative to a fixed member. However, ball bearing assemblies have many mechanical problems such as wear, run-out and manufacturing difficulties. Moreover, resistance to operating shock and vibration is poor because of low damping.

One alternative bearing design is a hydrodynamic bearing. In a hydrodynamic bearing, a lubricating fluid such as air or liquid provides a bearing surface between a fixed member of the housing (i.e., shaft) and a rotating member of the disc hub. In addition to air, typical lubricants include oil or ferromagnetic fluids. Hydrodynamic bearings spread the bearing interface over a large surface area in comparison with a ball bearing assembly, which comprises a series of point interfaces. This is desirable because the increased bearing surface reduces wobble or run-out between the rotating and fixed members. Further, the use of fluid in the interface area imparts damping effects to the bearing which helps to reduce non-repeat run out.

Another alternative design, which has been used with success, is a hydrodynamic groove disposed on journals, thrust, and conical hydrodynamic bearings. The hydrodynamic grooves provide a transport mechanism for fluid or air to more evenly distribute fluid pressure within the bearing, and between the rotating surfaces. The shape of the hydrodynamic grooves is dependant on the pressure uniformity desired. For example, a sinusoidal hydrodynamic groove provides a different pressure distribution than a herringbone or helix shaped hydrodynamic groove pattern. The quality of the fluid displacement and therefore the pressure uniformity is generally dependant upon the groove depth and dimensional uniformity. For example, a hydrodynamic groove having a non-uniform depth or shape may lead to pressure differentials, damping problems, etc. and therefore to subsequent premature hydrodynamic bearing or journal failure.

Generally, hydrodynamic bearing performance such as stiffness and damping is measure of a hub's ability to wobble about the shaft and withstand vibration. Wobble and run-out improves with hydrodynamic bearing stiffness and damping. Unfortunately, as the air or fluid within the hydrodynamic bearing provide some frictional element, the tighter the hydrodynamic bearing, the more power is consumed to rotate the hub about the shaft thereby increasing the disc drive's power requirements. Several factors affect the stiffness and damping of the hydrodynamic bearing including the gap between the rotating and non-rotating surfaces, the spacing between the hydrodynamic grooves, the ratio between the amount of surface area between the hydrodynamic grooves and the groove width (i.e., the groove pitch ratio), and the cross-section of the hydrodynamic grooves. Ideally, the hydrodynamic grooves are rectangular in cross-sectional profile for the most efficient transmission of the hydrodynamic bearing fluid. Unfortunately, as the hydrodynamic groove depths may be only microns deep, the manufacturing processes used to create the grooves are often inaccurate leaving groove profile shapes that vary between rectangular, trapezoidal, semi-sinusoidal, to sinusoidal. As the hydrodynamic groove profile affects bearing stiffness, damping, run-out, and power consumption, a large variation in hydrodynamic bearing groove profile may affect production throughput and disc drive power efficiency, reliability, and ultimately the cost of the disc drive.

Therefore, a need exists for a method and apparatus to provide a reliable hydrodynamic groove that provides a reliable and repeatable hydrodynamic bearing stiffness and damping.

### SUMMARY OF THE INVENTION

Embodiments of the invention generally provide a method for optimizing the performance of a hydrodynamic bearing used with a disc drive. In one embodiment, the invention generally provides a method of optimizing hydrodynamic grooves comprising, determining a range of optimized hydrodynamic bearing performance factors associated with a range of at least one hydrodynamic groove dimension values, and then selecting at least one of the optimized hydrodynamic bearing performance factors and associated hydrodynamic groove dimension value.

In another embodiment, the invention provides a hydrodynamic bearing having a plurality of hydrodynamic grooves disposed thereon, comprising a first of the plurality of hydrodynamic grooves having a cross-section wherein at least one value of the cross-section has been adapted to optimize at least one of a plurality of hydrodynamic bearing performance factors.

In another embodiment, the invention provides a method for optimizing the performance of a hydrodynamic bearing disposed within a hub and about a shaft on a disc drive. The method comprises a means for determining at least one hydrodynamic bearing performance factor, and a means for associating one or more values associated with a hydrodynamic groove cross-section with one or more of the hydrodynamic bearing performance factors.

### BRIEF DESCRIPTION OF THE DRAWINGS

So that the manner in which the above recited embodiments of the invention are attained and can be understood in detail, a more particular description of the invention, briefly summarized above, may be had by reference to the embodiments thereof which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a plan view of one embodiment of a disc drive for use with aspects of the invention.

FIG. 2A is a sectional side view depicting one embodiment of a spindle motor for use with aspects of the invention.

FIG. 2B is a partial sectional side view depicting one embodiment of the spindle motor of FIG. 2A.

FIG. 3 depicts a rectangular hydrodynamic groove cross sectional profile of a hydrodynamic bearing for use with aspects of the invention.

FIG. 4 depicts a trapezoidal hydrodynamic groove cross sectional profile of a hydrodynamic bearing for use with aspects of the invention.

FIG. 5 depicts a half sinusoidal hydrodynamic groove cross sectional profile of a hydrodynamic bearing for use with aspects of the invention.

FIG. 6 depicts a full sinusoidal hydrodynamic groove cross sectional profile of a hydrodynamic bearing for use with aspects of the invention.

FIG. 7 depicts a diagram showing the relationship between hydrodynamic bearing stiffness and hydrodynamic groove depth for use with aspects of the invention.

FIG. 8 depicts a diagram showing the relationship between hydrodynamic bearing stiffness and the ratio between hydrodynamic groove width and land width for use with aspects of the invention.

### DETAILED DESCRIPTION OF THE PREFERRED EMBODIMENTS

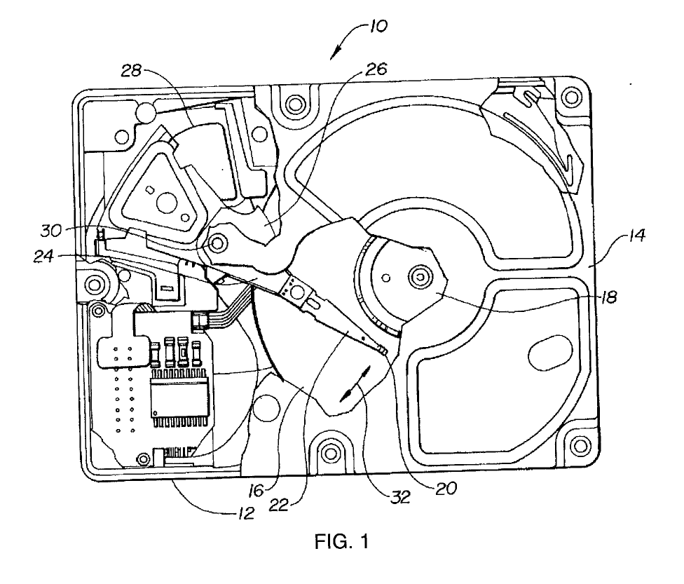

FIG. 1 depicts a plan view of one embodiment of a disc drive 10 for use with embodiments of the invention. Referring to FIG. 1, the disc drive 10 includes a housing base 12 and a top cover 14. The housing base 12 is combined with top cover 14 to form a sealed environment to protect the internal components from contamination by elements from outside the sealed environment. The base and top cover arrangement shown in FIG. 1 is well known in the industry. However, other arrangements of the housing components have been frequently used, and aspects of the invention are not limited to the configuration of the disc drive housing. For example, disc drives have been manufactured using a vertical split between two housing members. In such drives, that portion of the housing half which connects to the lower end of the spindle motor is analogous to base 12, while the opposite side of the same housing member, which is connected to or adjacent the top of the spindle motor, is functionally the same as the top cover 14. Disc drive to further includes a disc pack 16 which is mounted for rotation on a spindle motor (not shown) by a disc clamp 18. Disc pack 16 includes a plurality of individual discs that are mounted for co-rotation about a central axis. Each disc surface has an associated read/write head 20 which is mounted to disc drive 10 for communicating with the disc surface. In the example shown in FIG. 1, read/write heads 20 are supported by flexures 22 which are in turn attached to head mounting arms 24 of an actuator body 26. The actuator shown in FIG. 1 is of the type known as a rotary moving coil actuator and includes a voice coil motor (VCM), shown generally at 28. Voice coil motor 28 rotates actuator body 26 with its attached read/write heads 20 about a pivot shaft 30 to position read/write heads 20 over a desired data track along a path 32. While a rotary actuator is shown in FIG. 1, the invention may be used with other disc drives having other types of actuators, such as linear actuators.

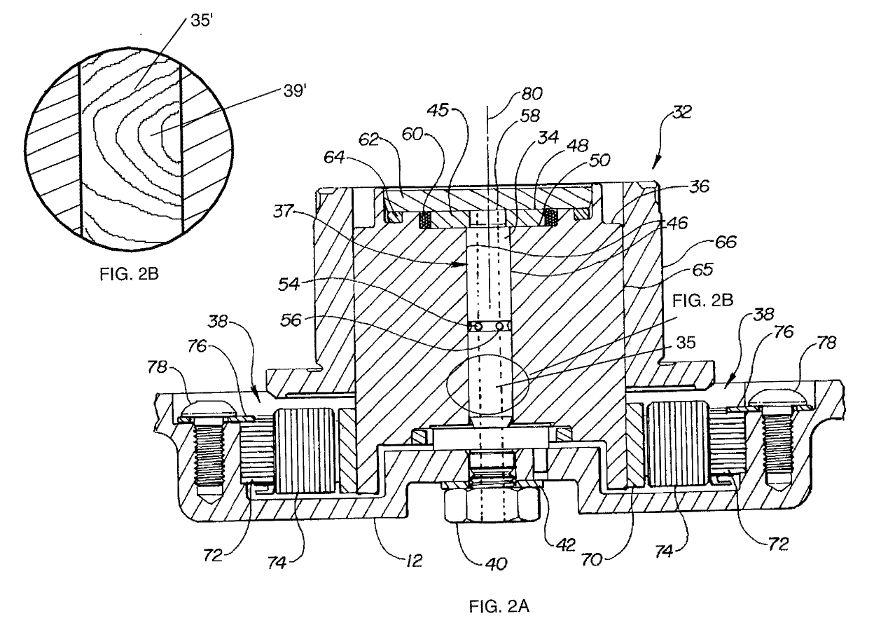

FIG. 2A is a sectional view of a hydrodynamic bearing spindle motor 32 in accordance with the invention. Spindle motor 32 includes a stationary member 34, a hub 36, and a stator 38. In the embodiment shown in FIG. 2A, the stationary member is a shaft that is fixed and attached to base 12 through a nut 40 and a washer 42. Hub 36 is interconnected with shaft 34 through a hydrodynamic bearing 37 for rotation about shaft 34. Hydrodynamic bearing 37 includes a radial working surface 46 (e.g., journal surface) and axial working surfaces 48 and 50 (e.g., thrust surface). Shaft 34 includes fluid ports 54, 56, and 58 which supply hydrodynamic fluid 60 and assist in circulating the fluid along the working surfaces of the hydrodynamic bearing 37. The hydrodynamic bearing 37 also includes a series of hydrodynamic grooves 35 positioned thereon. The hydrodynamic grooves 35 may be disposed upon the shaft 34, and/or the hub 36 to facilitate the supply and distribution of the hydrodynamic fluid 60 to the radial and axial working surfaces 46-50, of the hydrodynamic bearing 37. The hydrodynamic grooves 35 may be configured any number of ways depending on the hydrodynamic bearing load requirements. For example, the hydrodynamic grooves 35 may include sinusoidal grooves, herringbone grooves, helix grooves, and other similar grooves. The spacing between the hydrodynamic grooves 35 is defined as the “land” 39 which may vary between the hydrodynamic grooves 35 to accommodate various fluid flow requirements. For example, FIG. 2B illustrates a series of hydrodynamic grooves 35′ having a land 39′ portion between each hydrodynamic groove 35′ that approaches a maximum value near the apex of the hydrodynamic grooves 35′ to a minimum value near the end of each adjacent sinusoidal groove 35′. Hydrodynamic fluid 60 is supplied to shaft 34 by a fluid source (not shown), which is coupled to the interior of shaft 34 in a known manner. Spindle motor 32 further includes a thrust bearing 45, which forms the axial working surfaces 48 and 50 of hydrodynamic bearing 37. A counterplate 62 bears against working surface 48 to provide axial stability for the hydrodynamic bearing 37 and to position the hub 36 within spindle motor 32. An O-ring 64 is provided between counterplate 62 and hub 36 to seal the hydrodynamic bearing 37. The seal prevents hydrodynamic fluid 60 from escaping between counterplate 62 and hub 36. Hub 36 includes a central core 65 and a disc carrier member 66 which supports disc pack 16 (shown in FIG. 1) for rotation about shaft 34. Disc pack 16 is held on disc carrier member 66 by disc clamp 18 (also shown in FIG. 1). A permanent magnet 70 is attached to the outer diameter of hub 36, which acts as a rotor for a spindle motor 32. Core 65 is formed of a magnetic material and acts as a back-iron for magnet 70. Rotor magnet 70 can be formed as a unitary, annular ring or can be formed of a plurality of individual magnets which are spaced about the periphery of hub 36. Rotor magnet 70 is magnetized to form one or more magnetic poles. Stator 38 is attached to base 12 and includes a magnetic field focusing member or back-iron 72 and a stator winding 74. Stator winding 74 is attached to back-iron 72 between back-iron 72 and rotor magnet 70. Stator winding 74 is spaced radially from rotor magnet 70 to allow rotor magnet 70 and hub 36 to rotate about a central axis 80. Stator 38 is attached to base 12 through a known method such as one or more C-clamps 76 which are secured to the base through bolts 78. Commutation pulses applied to stator winding 74 generate a rotating magnetic field that communicates with rotor magnet 70 and causes hub 36 to rotate about central axis 80 on bearing 37. In the embodiment shown in FIG. 2A, spindle motor 32 is a “below-hub” type motor in which stator 38 is positioned below hub 36. Stator 38 also has a radial position that is external to hub 36, such that stator winding 74 is secured to an inner diameter surface 82 of back-iron 72.

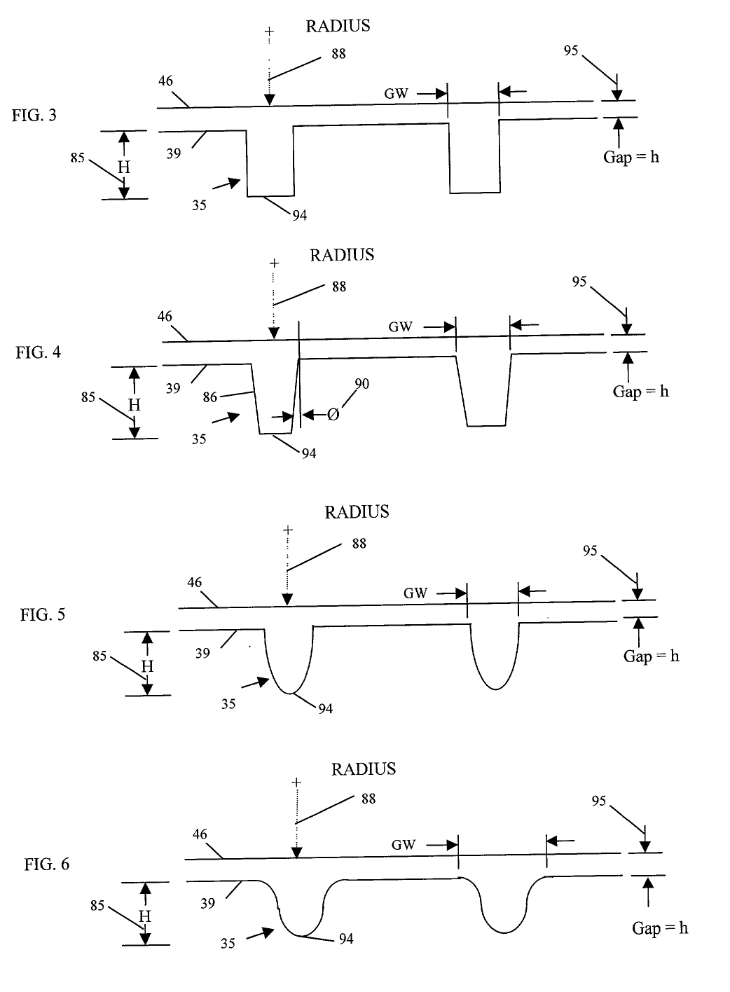

FIGS. 3-6 depict embodiments of a surface topography of a hydrodynamic bearing 37 for use with aspects of the invention. FIGS. 3-6 depict only a few of the plurality of hydrodynamic groove cross-sectional shapes from rectangular through sinusoidal cross-sections. For example, FIG. 3 illustrates one embodiment of rectangular hydrodynamic groove 35 having a rectangular cross-section. FIG. 4 illustrates one embodiment of trapezoidal hydrodynamic groove 35′ where the sidewalls of the 92 of the trapezoidal hydrodynamic groove 35′ are sloped. FIG. 5 illustrates one embodiment of semi-sinusoidal hydrodynamic groove 35″ where hydrodynamic groove 35 is semi-sinusoidal in cross-section. FIG. 6 illustrates one embodiment of sinusoidal hydrodynamic groove 35′″ where the hydrodynamic groove 35 is sinusoidal in cross-section. While FIGS. 3-6 depict specific rectangular, trapezoidal, semi-sinusoidal, and sinusoidal cross-sections of hydrodynamic grooves 35, other hydrodynamic groove shapes are contemplated such as, for example, a trapezoidal groove shape having a semi-sinusoidal or an irregular shaped bottom.

Generally, hydrodynamic groove characteristics such as the cross-section area, size, layout, and number of hydrodynamic grooves 35 affect the pumping efficiency of the hydrodynamic fluid 60 about the hydrodynamic bearing 37. The pumping efficiency can affect hydrodynamic bearing performance factors such as stiffness (e.g., radial, axial and/or rocking stiffness), damping, run-out, power consumption, and other factors that affect the performance of the disc drive 10. Too many hydrodynamic grooves 35 that have an improper cross-sectional area (i.e., shape) can also affect the pumping efficiency and therefore the hydrodynamic bearing performance factors. In one aspect, the hydrodynamic grooves 35 cross-sectional dimensions and/or the number the hydrodynamic grooves 35 are adjusted to establish an about optimum range of hydrodynamic bearing performance factors. For example, the groove dimensions such as hydrodynamic groove width GW, depth, and profile may be adjusted accordingly to optimize one or more of the hydrodynamic bearing performance factors.

In another aspect, the group pitch ratio (GPR), which is the ratio of the hydrodynamic groove width GW to the land width, may be adjusted in addition to or in lieu of other hydrodynamic groove dimensions to optimize the hydrodynamic bearing performance factors. In one aspect, the GPR may be defined as the ratio of the hydrodynamic groove width GW to the number of grooves per circumference of the hydrodynamic bearing 37 (i.e. pitch). The groove pitch ratio is illustrated in formula 1.

$$\frac{GW}{( 2 π R )} \times ( N ) \qquad ( 1 )$$

The greater the groove width GW for a given number of grooves N within a specified circumference of the hub or shaft, for example, the higher the groove/pitch ratio. In embodiment, the radius R 88 may be a measure of the distance from the longitudinal rotational axis of the rotating surface to the surface(s) having the hydrodynamic grooves 35 thereon such as the working surfaces 46. However, if the grooves are on a non-rotating surface, the radius R 88 may be measured from the rotating axis to the non-rotating surface. Further, adjusting one or more of the hydrodynamic groove dimensions, and/or the GPR, may be used to optimize the hydrodynamic bearing performance factors.

In one embodiment, a method is used to establish an optimized range of hydrodynamic bearing performance factors. In one aspect, the method includes measuring and/or modeling a plurality of hydrodynamic bearing performance factors as a function of various modified hydrodynamic groove cross-sectional dimensions. For example, the depth of the hydrodynamic grooves 35 are modified to establish an optimal range of hydrodynamic bearing performance factors with respect to a gap 95. The hydrodynamic bearing performance factors are then measured and/or calculated, and data analyzed to determine the optimum range of hydrodynamic groove depths for a particular gap 95. In another example, the GPR is modified to establish an optimal range of hydrodynamic bearing performance factors. The hydrodynamic bearing performance factors are then measured and/or calculated and data analyzed to determine the optimum range of GPRs. It is contemplated that one or more of the hydrodynamic groove cross-sectional dimensions and/or dimension ratios (e.g., GPR) may be modified and/or modeled. The resulting hydrodynamic bearing performance factors may then be measured and/or calculated to establish a particular range of one dimension (e.g., depth), or combinations of dimensions (e.g., depth, width, etc.) to optimize the hydrodynamic bearing performance factors. Alternatively, it is contemplated that one or more hydrodynamic groove dimensions may be selected and the gap 95 dimensions may be modified to provide an optimal range of hydrodynamic bearing performance factors.

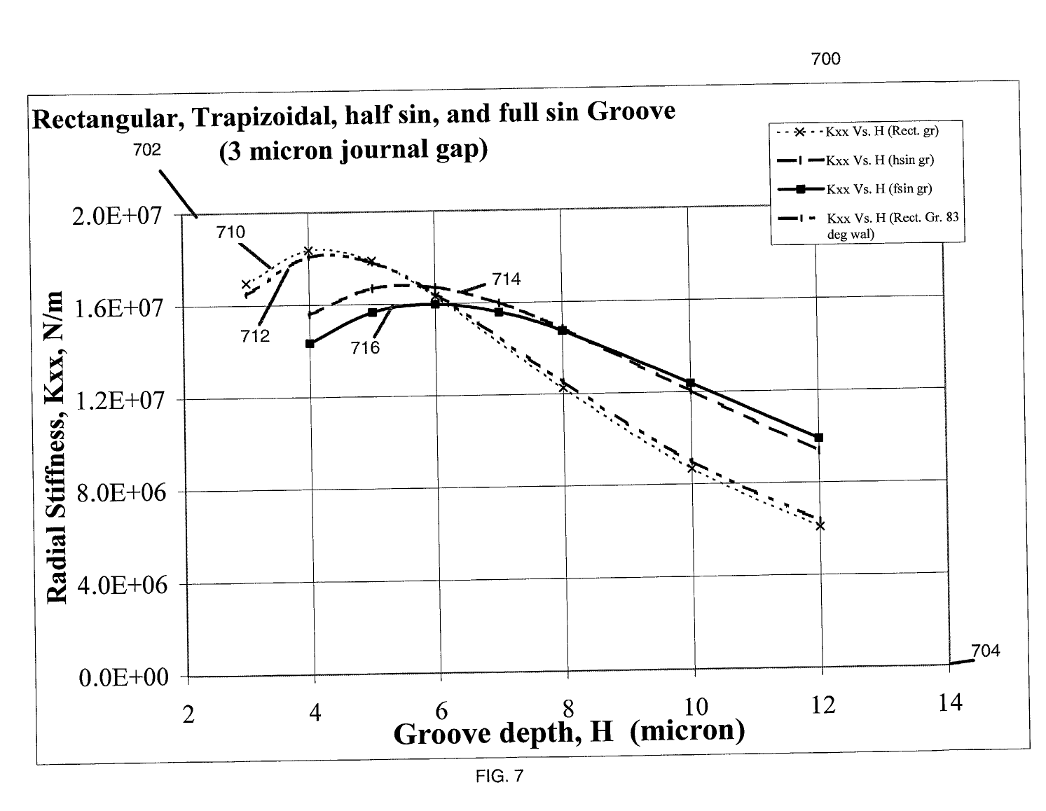

FIG. 7 depicts a graph 700 of one embodiment of a hydrodynamic bearing performance factor model showing the relationship between hydrodynamic radial bearing stiffness 702 and various hydrodynamic groove shapes 35-35′″. FIGS. 3-6 are referenced as needed with the discussion of FIG. 7.

As illustrated in graph 700, at a specified gap 95 of about three microns, the radial stiffness varies (i.e. y-axis) as a function of the hydrodynamic groove depth H 85 (i.e., x-axis) between values about 5.0 E+06 N/M to about 1.8 E+06 for the various hydrodynamic groove shapes 35-35′″ as plotted as plots 710-716 respectively. Using the graph 700, an optimized range of values may be obtained with respect to the gap 95. In one aspect, the inventors believe the optimal range for the various hydrodynamic groove shapes 35-35′″, that a desired range of bearing stiffness values are about optimized for a ratio of about between about 1.2 h and about 2.4 h, where h is the gap 95 dimension.

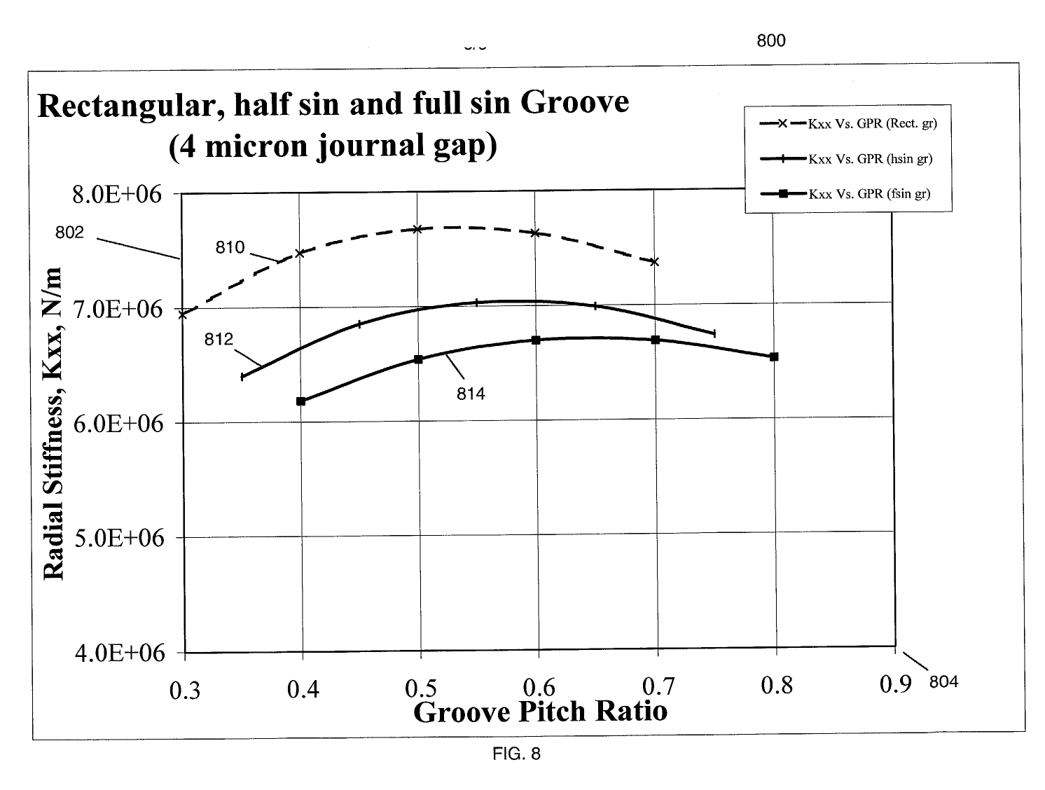

FIG. 8 depicts a graph 800 of one embodiment of a hydrodynamic bearing performance factor model showing the relationship between hydrodynamic radial bearing stiffness 702 and various GPR ratios. FIGS. 3-7 are referenced as needed with the discussion of FIG. 8.

As illustrated in graph 800, at a specified gap 95 of about four microns, the radial stiffness (i.e. y-axis) varies as a function of the GPR between values about 6.1 E+06 N/M to about 7.2 E+06 for the various hydrodynamic groove shapes 35-35′″ as plotted as plots 810-814 respectively. Using the graph 800, an optimized range of values may be obtained with respect to the gap 95. In one aspect, the inventors believe the optimal range for the various hydrodynamic groove shapes 35-35′″, that a desired range of GPR values are about optimized between a GPR of between about 0.4 to about 0.7.

While the foregoing is directed to embodiments of the invention, other and further embodiments of the invention may be devised without departing from the basic scope thereof, and the scope thereof is determined by the claims that follow.

1. A method of optimizing hydrodynamic grooves, comprising;
determining a range of optimized hydrodynamic bearing performance factors associated with a range of at least one hydrodynamic groove dimension values; and
configuring at least one of the hydrodynamic grooves to at least one of the optimized hydrodynamic bearing performance factors and associated hydrodynamic groove dimension value.

2. The method of claim 1, wherein the at least one hydrodynamic groove dimension values includes a depth dimension.

3. The method of claim 2, wherein the depth dimension is between about 1.2 to 2.4 times the nominal bearing gap dimension.

4. The method of claim 1, wherein the at least one hydrodynamic groove dimension values includes a groove pitch ratio defined by a ratio between the width of the hydrodynamic groove and pitch.

5. The method of claim 4, wherein groove pitch ratio is between about 0.4. to about 0.7.

6. A hydrodynamic bearing having a plurality of hydrodynamic grooves disposed thereon, wherein at least one of the hydrodynamic grooves comprises optimizing means for optimizing at least one of a plurality of hydrodynamic bearing performance factors.

7. The apparatus of claim 6, wherein the optimizing means of comprises a hydrodynamic groove cross-section being at least one of a rectangular cross-section, trapezoidal cross-section, semi-sinusoidal cross-section, sinusoidal cross-section, and combinations thereof.

8. The apparatus of claim 6, wherein the plurality of hydrodynamic bearing performance factors include, radial/axial/rocking stiffness, axial stiffness, run-out, damping, power consumption, and combinations thereof.

9. The apparatus of claim 6, wherein a value of the hydrodynamic bearing groove includes at least one dimension that is associated with the at least one of a plurality of hydrodynamic bearing performance factors.

10. The apparatus of claim 9, wherein the at least one dimension comprises at least one of a depth, width, gap dimension, and combinations thereof.

11. The apparatus of claim 9, wherein the at least at least one dimension comprises a depth dimension that is within a range of about 1.2 to about 2.4 times the nominal bearing gap dimension.

12. The apparatus of claim 12, wherein the at least one value of the cross-section comprises a groove pitch ratio defined by a ratio between the width of the hydrodynamic grooves and the pitch.

13. The apparatus of claim 12, wherein the groove pitch ratio is between about 0.4 to about 0.7.

14. A method for optimizing the performance of a hydrodynamic bearing disposed within a hub and about a shaft on a disc drive, comprising:
means for determining one or more hydrodynamic bearing performance factors; and
means for associating one or more values associated with a hydrodynamic groove cross-section with the one or more hydrodynamic bearing performance factors and then configuring one or more hydrodynamic grooves to at least one of the values.

15. The method of claim 14, wherein determining comprises modeling the one or more hydrodynamic bearing performance factors.

16. The method of claim 14, wherein determining comprises measuring the one or more hydrodynamic bearing performance factors.

17. The method of claim 14, wherein the one or more hydrodynamic bearing performance factors comprise radial/axial/rocking stiffness, axial stiffness, run-out, damping, power consumption, and combinations thereof.

18. The method of claim 14, wherein the one or more values associated with the hydrodynamic groove cross-section is a range of values associated with a range of the one or more hydrodynamic bearing performance factors.

19. The method of claim 18, wherein the range of values is a range of depth dimensions and further comprising selecting the range of the depth dimensions within a range of between about 1.2 to about 2.4 times the nominal bearing gap dimension.

20. The method of claim 18, wherein the range of values is a range of groove pitch ratio values and further comprising selecting the range of groove pitch ratio values within a range of between about 0.4 to about 0.7.
